(19) United States
(12) Patent Application Publication
(10) Pub. No.: US 2024/0246882 A1
(43) Pub. Date: Jul. 25, 2024

(54) CONTROLLED RELEASE FERTILIZER COMPRISING PHOSPHATE BASED GLASS

(71) Applicant: TURKIYE SISE VE CAM FABRIKALARI ANONIM SIRKETI, lstanbul (TR)

(72) Inventor: Bahar KUZU, Istanbul (TR)

(73) Assignee: TURKIYE SISE VE CAM FABRIKALARI ANONIM SIRKETI, Istanbul (TR)

(21) Appl. No.: 18/289,597

(22) PCT Filed: Apr. 7, 2022
(86) PCT No.: PCT/TR2022/050307

§ 371 Date: Nov. 6, 2023

(30) Foreign Application Priority Data
May 5, 2021 (TR) 2021/007704

(51) Int. Cl. C05G 3/40; C05B 13/00; C05D 9/02

(52) U.S. Cl. CPC C05G 3/40; C05B 13/00; C05D 9/02

(57) ABSTRACT

A controlled release phosphate-based glass fertilizer composition includes at least one macro element selected from the group consisting of 28-50P₂O₅, 36>CaO, 25>SiO₂, 0.1-10 Al₂O₃, 20>Na₂O, and 20>K₂O as a mole percent, an oxide selected from the group consisting of SO₃ and MgO, and a microelement selected from the group consisting of Mn, Cu, B, Mo, Zn, and Fe. The controlled release phosphate-based glass fertilizer composition has a glass transition temperature which is adjusted above 230° C.

### CROSS REFERENCE TO THE RELATED APPLICATIONS

This application is the national phase entry of International Application No. PCT/TR2022/050307, filed on Apr. 7, 2022, which is based upon and claims priority to Turkish Patent Application No. 2021/007704, filed on May 5, 2021, the entire contents of which are incorporated herein by reference.

### TECHNICAL FIELD

The present invention relates to the controlled release fertilizers, particularly to a glass fertilizer which is phosphate-based and comprises the other oxides.

### BACKGROUND

Plants need particular nutrient elements during their development process. C, H, and O, which constitute a large portion of them, are supplied from the air and water. Macro nutrient elements such as N, P, K, Mg, Ca, S, and micro nutrient elements such as B, Mo, Cu, Zn, Mn, Fe, Cl are taken from the soil. The fertilizers are widely used in order to increase the yield by supplementing these macro and micro nutrient elements required by the plant to the soil. The controlled release fertilizers (CRF) have also started to take place in the fertilizer sector with the aim of making an efficient agricultural production. The controlled release fertilizer term refers to a fertilizer that releases the nutrient elements in its structure into a medium over a long period of time. Since the controlled release fertilizers show controlled release, the amount of nutrient elements lost by washing from the soil in their use is significantly reduced. This provides a direct increase in the nutrient element uptake of the plants.

Glass has become a very popular material in the technology of controlled release fertilizer. Glass, which has no harmful effects on the environment, can contain many nutrient elements in its structure and as a result of its dissolution behavior in the soil medium, it contributes to plant nutrition by releasing the nutrients in its structure in a controlled manner. However, the chemical stability of glasses can be changed by the differences in its composition and glass fertilizers can be synthesized in accordance with the development processes and the needs of different plant species in terms of both content and dissolution.

The glass types studied in the literature are divided into two as silica-based and phosphate-based glasses. Although phosphate is a very good glass network former, the chemical stability thereof is very low when used alone. However, the chemical stability of phosphate glasses can be changed in a wide range by adding different components to the structure and by changing the ratios of the components. There are publications on phosphate glasses, which have a high potential for controlled release glass fertilizers due to their modifiable chemical stability.

U.S. Pat. No. 6,488,735 discloses a fertilizer component having a glass matrix containing, along with the network former oxides, a phosphorus pentoxide completely or partially instead of silica, modifier oxides of the glass matrix, as well as potassium oxide completely or partially instead of sodium oxide and containing one or more trace elements.

### SUMMARY

The primary objective of the present invention is to provide a controlled release fertilizer containing a phosphate-based glass composition, the release period of which can be adjusted widely depending on the type of the plant to be fertilized.

The present invention is a controlled release glass fertilizer composition comprising at least one macro element selected from the group comprising 28-50P₂O₅, 36>CaO and also 25>SiO₂, 0.1-10Al₂O₃, 20>Na₂O, 20>K₂O as a mole percent, preferably an oxide selected from the group comprising SO₃, MgO, and preferably a microelement selected from the group comprising Mn, Cu, B, Mo, Zn, Fe and having a glass transition temperature adjusted above 230° C. In a possible embodiment, the glass transition temperature is above 300° C. The samples of the P₂O₅— CaO—Na₂O—K₂O, P₂O₅— CaO—Al₂O₃— Na₂O—K₂O, P₂O₅— CaO—SiO₂— Al₂O₃— Na₂O—K₂O systems were produced by using the conventional melting casting method in the varying ratios of Na₂O/Na₂O+K₂O, Al₂O₃/P₂O₅ and SiO₂/Na₂O+K₂O in the composition, respectively.

In a preferred embodiment, Na₂O and K₂O were selected from the group together as a macro element. In this case, it was determined that the dissolution rate was positively affected by the effect of mixed alkali.

In a possible configuration, it is possible to add nitrogen or the oxide thereof to the group as a macro element.

P₂O₅—CaO—Na₂O—K₂O

In a preferred embodiment, the macro elements are composed of P₂O₅, CaO, Na₂O, K₂O. Further, it comprises preferably SO₃, MgO, SiO₂ ve Al₂O₃ as oxides. Preferably, the components that form the glass composition are selected as 28-50P₂O₅— 10-35CaO—10-20Na₂O (particularly 13-17)-10-30K₂O in a mole ratio. In the P₂O₅— CaO—Na₂O—K₂O system, it was observed that nonlinear changes occurred in the T_{g} values of the samples with an increasing ratio of Na₂O/K₂O+Na₂O and in the peak intensities and bandwidths of the PO₃⁻² group of the Q¹ structural unit and the PO₂⁻ group of the Q² structural unit; and it was determined that the mixed alkali effect caused this situation. Preferably, the density was adjusted to 2.54 g/cm³ for the mole percent ratio of 50P₂O₅2OCaO15K₂O15Na₂O according to the ratio of Na₂O/Na₂O+K₂O in the composition. As a result of the weight loss examinations of the samples of the P₂O₅— CaO—Na₂O—K₂O system, it was determined that the sample of 50P₂O₅2OCaO15K₂O15Na₂O showed the slowest dissolution behavior. It is known that the dissolution mechanism in glasses is based on the exchange of alkali ions in the glass structure with hydrogen ions in the liquid medium and that the dissolution rate is controlled by the rate of ion migration in the hydrated glass layer and hydrolysis is also involved. Accordingly, it was determined that the slow dissolution behavior of the sample of 50P₂O₅2OCaO15K₂O15Na₂O was caused by the low ionic migration rate due to the mixed alkali components therein.

In the preferred embodiment, the wave number of the FTIR spectrum comprises a reflectance peak between 520-540, 865-880, 1080-1090, 1260-1340 cm⁻¹.

In a preferred embodiment, a pH change in the citric acid solution of 2% is adjusted less than 0.75, preferably less than 0.5 for over 600 hours.

P₂O₅—CaO—Al₂O₃—Na₂O—K₂O

In the P₂O₅— CaO—Al₂O₃— Na₂O—K₂O system, it was determined that along with an increasing ratio of Al₂O₃, an increase occurred in T_{g} values and the Q¹ structural unit became more dominant in the structure. It was determined that this is a result of A13'⁰ ion with a high field intensity increasing the cross-links in the structure.

In the P₂O₅— CaO—Al₂O₃— Na₂O—K₂O system, it was determined that the chemical stability of the glass was improved significantly as a result of the addition of Al₂O₃ to the structure and the increase in the cross-links between the phosphate chains in the network structure, but that the dissolution rate accelerated in an acidic medium with a higher ratio of Al₂O₃.

On the other hand, in a preferred embodiment, the macro elements are formed from P₂O₅, CaO, Al₂O₃, Na₂O, K₂O. Preferably, the mole ratio of Al₂O₃ is chosen between 3-7. SiO₂ is preferably chosen between 5-15 mole ratios.

In a preferred embodiment of the invention, according to the ratio of Al₂O₃/P₂O₅ in the composition, the density was adjusted to 2.63 g/cm³ for the mole percent ratio of 45P₂O₅20CaO5Al₂O₃15Na₂O15K₂O.

Preferably, the wave number of the FTIR spectrum comprises a reflectance peak between 530-550, 880-905, 1100-1120, 1180-1270 cm⁻¹.

Preferably, the pH change in the citric acid solution of 2% is adjusted less than 0.75 for over 600 hours. It was determined that the chemical resistance increased in the acidic solvent medium with Al₂O₃ added to the structure, but that decreased in the neutral medium.

P₂O₅—CaO—SiO₂—Al₂O₃—Na₂O—K₂O

In a preferred embodiment of the invention, the macro elements are composed of P₂O₅, CaO, SiO₂, Al₂O₃, Na₂O and K₂O.

Preferably, the density was adjusted to 2.60 g/cm³ for the mole percent ratio of 45P₂O₅20CaO5SiO₂5Al₂O₃12.5Na₂O12.5K₂O according to the ratio of SiO₂/Na₂O+K₂O in the composition. By evaluating the physical, thermal, structural analysis results and dissolution behavior of all synthesized samples, it was determined that the sample of 45P₂O₅20CaO5SiO₂5Al₂O₃12.5Na₂O12.5K₂O is the most suitable glass for the development of tomato plants. It was determined that an increase occurred in the T_{g} value with SiO₂ added to the structure, while Si—O—P bonds were formed in the structure. The microelement is used as the glass fertilizer in the pot experiments performed with the tomato plant with additives (MnO₂, Fe₂O₃, ZnO, B₂O₃, CuO, MoO₃) and without additives. Preferably, the wave number of the FTIR spectrum comprises a reflectance peak between 490-535, 880-895, 1090-1100, 1260-1265 cm⁻¹. Preferably, the pH change in the citric acid solution of 2% is adjusted less than 0.75 for over 600 hours.

P₂O₅—CaO—MgO—Na₂O—K₂O

The invention preferably comprises the P₂O₅— CaO—MgO—Na₂O—K₂O system. The sample of 50P₂O₅20CaO7.5MgO7.5Na₂O15K₂O can be obtained as homogeneous glass with the assayed production parameters.

A preferred embodiment of the invention includes the use of a glass fertilizer composition in the production of tomato (Lycopersicon Esculentum), except for a sample of 50P₂O₅20CaO30K₂O suitable for any of the above embodiments. As a result of the pH monitoring carried out, it was determined that no sample significantly alter the pH of the acidic solvent medium and the pH values of the medium were in a pH range ideal for the development of tomato plants during their dissolution in neutral medium, except for the sample of 50P₂O₅20CaO30K₂O.

### BRIEF DESCRIPTION OF THE DRAWINGS

FIGS. 1A-1C are graphical representations of a change in density (p) and molar volume (VM) according to the varying ratio of Na₂O (FIG. 1A), Al₂O₃(FIG. 1B) and SiO₂ (FIG. 1C).

FIG. 2 is a representation of DTA analysis results of glass samples.

FIG. 3 is a representation of FTIR spectra of glass samples.

FIGS. 4A-4B are representations of time-dependent weight loss of glass samples in 2% citric acid (FIG. 4A) and distilled water (FIG. 4B).

FIGS. 5A-5B are representations of pH-time graph of 2% citric acid (FIG. 5A) and distilled water (FIG. 5B).

### DETAILED DESCRIPTION OF THE EMBODIMENTS

In this detailed description, the configurations of the invention and its preferred embodiments are described only for a better understanding of the subject and in a non-limiting sense.

Application areas of phosphate glasses remained restricted in the past due to their low chemical resistance properties. The poor chemical resistance of phosphate glasses is thought to be originated from the asymmetry of the PO4 tetrahedron which is the basic building block of phosphate glass. Nevertheless in recent years, phosphate glasses have become an intensively studied material for the controlled release fertilizers. The dissolution behavior of phosphate glasses depends on the glass composition, the pH value of the solvent medium, the temperature, the thermal history of the glass, and the glass surface area.

In the studies in the literature, it has been stated that three types of reactions may play a role during the dissolution of phosphate glass in a liquid medium. These are the acid-base, hydrolysis and hydration reactions. The acid-base reaction is responsible for the disruption of the ionic interaction between the chains in the network structure, which is highly pH dependent. During the hydration reaction, the highly mobile cations (such as Na+) in the glass structure are replaced with the H+ ions in the water structure. As a result of this ion exchange, a hydration layer is formed at the glass-water interface. At this stage, P—O—P bonds in the hydration layer are broken by the effect of the water molecules and the hydrogen ions, and the hydrolysis reaction takes place. This results in the deterioration of the network structure of the glass and the passage of the phosphate chains of different lengths into solution. This step highly depends on the ambient pH, as it will accelerate with the increase of the H+ ion concentration in the solution. In an acidic medium, the protons increase the dissociation of the P—O-M bonds. Therefore, as compared to a neutral medium, an acidic medium will lead to a higher rate of hydration reaction and dissolution.

In the disclosed embodiments of the invention, the samples of different phosphate-based glass compositions were produced by the conventional melting casting method, the glass samples obtained were examined physically, thermally and structurally, the dissolution behavior of the glass samples in the different solvent media was monitored and the effect of the composition change on the chemical stability of the glass was determined. In the light of the data obtained, the glass fertilizer composition, which is thought to be the most suitable for use in the development of the tomato plant, was determined and the microelements required by the plant were also added to this composition. The samples of glass compositions with and without the microelement additives were used to grow the tomato plants, and the effect of the obtained glass fertilizer on plant growth was investigated.

During the production of glass samples, P₂O₅ (99.0%, Sigma Aldrich), CaCO₃ (99%, Merck-Suprapur), Na₂CO₃ (99.5%, Alfa Aesar), K₂CO₃ (98.5%, Sigma Aldrich), MgO (98%, Sigma Aldrich), Al₂O₃ (99.9%, Alfa Aesar), SiO₂ (99.8%, Sigma Aldrich), ZnO (99%, Merck-Supelco), CuO (99%, Alfa Aesar), Fe₂O₃ (99.5%, Alfa Aesar), MoO₃ (99.95%, Alfa Aesar), MnO₂ (95%, Honeywell-Riedel de Haen) and H₃BO₃ (99.9%, Zag Kimya) powders of high purity were used as a starting material. The carbonate compounds of the alkaline earth and the alkalis used as the starting materials turned into the oxides as a calcined form during melting. The properties of the oxidized compounds involved in the sample production are given in Table 1.

TABLE 1
The properties of the oxidized compounds involved in the sample production

| | Molecular | | Melting | Boiling | |
|---|---|---|---|---|---|
| | Weight | Density | point | point | Crystalline |
| Component | (g/mol) | (g/cm³) | (° C.) | (° C.) | structure |
| P₂O₅ | 141.94 | 2.3 | 340 | 360 | Orthorhombic |
| CaO | 56.08 | 3.34 | 2572 | 2850 | Cubic |
| Na₂O | 61.979 | 2.27 | 1132 | 1950 | Cubic |
| K₂O | 94.2 | 2.35 | T > 340° C., | — | Cubic |
| | | | degradation | | |
| MgO | 40.30 | 3.58 | 2852 | 3600 | Cubic |
| Al₂O₃ | 101.96 | 3.95 | 2072 | 2977 | Hexagonal |
| SiO₂ | 60.08 | 2.65 | 1710 | 2230 | Trigonal |
| MnO₂ | 86.94 | 5.03 | T > 535° C., | — | Rutile |
| | | | degradation | | |
| Fe₂O₃ | 159.69 | 5.25 | T > 1565° C., | — | Trigonal |
| | | | degradation | | |
| ZnO | 81.37 | 5.6 | 1974 | 2360 | Wurtzite |
| B₂O₃ | 69.63 | 2.46 | 450 | 1500 | Trigonal |
| CuO | 79.545 | 6.315 | 1326 | 2000 | Monoclinic |
| MoO₃ | 143.95 | 4.70 | 802 | 1155 | Orthorhombic |

During the sample production, the calculations were made based on the molar weights of the raw materials used. The denomination of the samples was made by writing the initials of the components and the theoretical mole percentages side by side. The sample codes are given in Table 2 and Table 3 along with their compositions.

TABLE 2
Glass sample codes and their compositions

| | Composition (mol %) | | | | | | |
|---|---|---|---|---|---|---|---|
| Sample Code | P₂O₅ | CaO | Na₂O | K₂O | MgO | Al₂O₃ | SiO₂ |
| P50C20K30 | 50 | 20 | — | 30 | — | — | — |
| P50C20N15K15 | 50 | 20 | 15 | 15 | — | — | — |
| P50C20N30 | 50 | 20 | 30 | — | — | — | — |
| P50C20M7.5N7.5K15 | 50 | 20 | 7.5 | 15 | 7.5 | — | — |
| P50C20M15K15 | 50 | 20 | — | 15 | 15 | — | — |
| P45C20A5N15K15 | 45 | 20 | 15 | 15 | — | 5 | — |
| P40C20A10N15K15 | 40 | 20 | 15 | 15 | — | 10 | — |
| P45C20S5A5N12.5K12.5 | 45 | 20 | 12.5 | 12.5 | | 5 | 5 |

TABLE 3
Microelement additive-containing glass sample code and their compositions

| | Composition (mol %) | | | | | | | | | | | |
|---|---|---|---|---|---|---|---|---|---|---|---|---|
| Sample Code | P₂O₅ | CaO | Na₂O | K₂O | Al₂O₃ | SiO₂ | MnO₂ | Fe₂O₃ | ZnO | B₂O₃ | CuO | MoO₃ |
| P45C20S5A5N12.5K12.5-M | 44.5 | 20 | 12 | 12 | 4.5 | 5 | 0.5 | 0.3 | 0.3 | 0.3 | 0.3 | 0.3 |

For the purpose of producing the glass samples, according to the compositions determined, the raw materials were weighed on Precisa™ 10⁻⁴ precision scales and a homogeneous powder mixture was obtained by mixing them in an agate mortar. The prepared powder mixtures were melted in the Protherm PLF 160/9 furnace, and due to the change in the composition, a 30-minute preheat step at 700° C. was added to the production process for some samples. The melting process was carried out for 20 and 60 minutes for samples with different compositions, and the melting temperature varied between 1000° C.-1300° C. After melting, the samples were poured into a preheated stainless steel mold and then subjected to stress relief annealing for 3 hours at temperatures ranging from 250° C.-380° C. in a Protherm PLF 120/5 furnace. After annealing, the samples were cooled down to the room temperature in a controlled manner in the furnace. Before the characterization stage, one surface of the obtained samples was sanded with 320, 800, 1200 and 2500 grit sandpapers, respectively, and polished with diamond paste (Struers—diaduo-2). The chemical analysis of the samples was performed using an X-ray fluorescence spectrometry (XRF) method for the selected samples in order to detect whether there was any deviation in the composition during manufacture. The prepared powder samples were mixed with cellulose at a ratio of ⅓ and then pressed and analyzed with the Rigaku—ZSX Primus II model XRF device. In order to interpret the changes in the glass structure depending on the composition of the samples obtained, the values of density, ρ, molar volume, V_{M}, oxygen molar volume, V_{O}, oxygen packing density, OPD, were calculated.

The densities of the glass samples were determined by 3 repetitive measurements using the Archimedes method on a precision scale with a sensitivity of 10⁻⁴, and ethanol was used as a dipping liquid. The densities of the glass samples were calculated according to Equation 1.

$$ρ = \frac{{W}_{Air}}{{W}_{Air} - {W}_{Ethanol}} \times {ρ}_{Ethanol} \qquad ( 1 )$$

In the equation, ρ is the density of the glass, ρ_{Ethanol} is the density of the ethanol used as the dipping liquid, W_{Air} is the weight of the glass in the air, and W_{Ethanol} is the weight of the glass in ethanol.

The molar volumes, V_{M}, of the glass samples were calculated according to Equation 2.

$${V}_{M} = \frac{\sum {X}_{i} {M}_{i}}{ρ} \qquad ( 2 )$$

According to the equation, Xᵢ is the mole fraction of the components, Mᵢ is the molecular weight of the components, and ρ is the density of the sample.

The oxygen molar volumes, V_{O}, of the glass samples were calculated according to Equation 3.

$${V}_{O} = ( \frac{\sum {X}_{i} {M}_{i}}{ρ} ) ( \frac{1}{\sum {X}_{i} {n}_{i}} ) \qquad ( 3 )$$

According to the equation, Xᵢ is the mole fraction of the components, Mᵢ is the molecular weight of the components, ρ is the density of the sample, and nᵢ is the number of oxygen atoms in each oxide.

The oxygen packing densities, OPD, of the glass samples were calculated according to Equation 4

$$OPD = 1000 C ( \frac{ρ}{M} ) \qquad ( 4 )$$

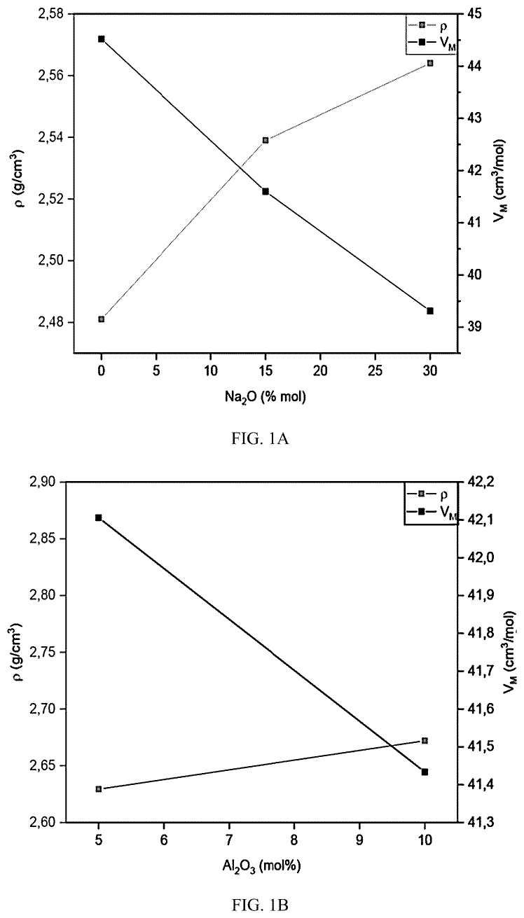

In the equation, C is the number of oxygen atoms for each composition, p is the density, and M is the molecular weight. FIGS. 1A-1C show graphically a representation of the change in density (p) and molar volume (VM) according to the varying ratio of Na₂O, Al₂O₃ and SiO₂.

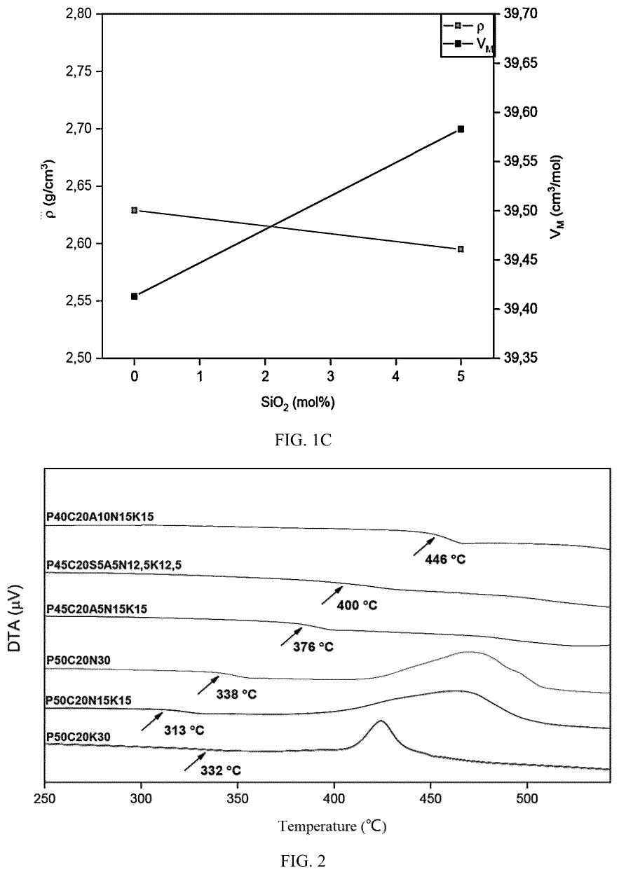

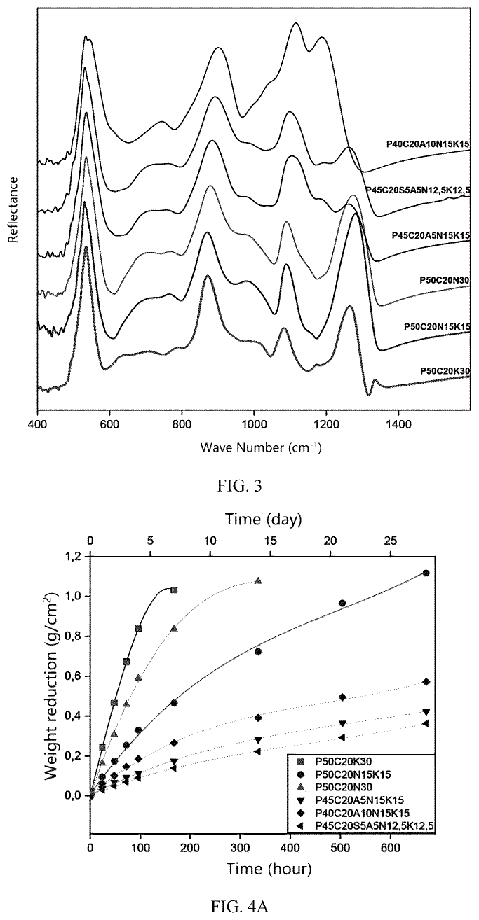

The thermal properties of the obtained glass samples were determined by the differential thermal analysis (DTA) method. FIG. 2 shows the results of DTA analysis of the glass samples. The thermal analyzes of the samples were carried out with the EXSTA®6000 TG/DTA 6300 device, and the powder samples of 25±1 mg were heated in the aluminum pots at a rate of 10° C./min up to 550° C. in N atmosphere. As a result of the thermal analysis, the glass transition (Tg), the crystallization onset (Tc) and the peak (Tp) temperatures and thermal stability (ΔT) values of the samples were determined. The thermal stability values, which are a measure of the resistance of the glass samples to crystallization, were calculated by considering the difference between the crystallization onset temperature and the glass transition temperature, ΔT=Tc−Tg. The structural analyzes of the samples were investigated using the Fourier Transform Infrared Spectroscopy (FTIR) technique. The FTIR spectra of the glass samples were obtained using a Bruker Hyperion 3000 model FTIR device, in the wave number range of 400-4000 cm⁻¹ and in the reflectance mode. FIG. 3 shows the FTIR spectrum of the glass samples mentioned here.

FTIR analysis of the sample of P45C20S5A5N12.5K12.5-M was performed on a powder sample using Bruker Vertex 70 instrument with Pt ATR in the wave number range of 400-4000 cm⁻¹. In order to examine the dissolution behavior of the synthesized samples, the time-dependent weight loss was monitored in two different media, distilled water and 2% citric acid solution. While the distilled water used as a solvent represents a neutral medium, the 2% citric acid solution simulates the pH value of the medium where the nutrient elements are taken from the root region into the plant. The samples obtained for the weight loss studies were placed in both solvent media based on the ratio of the sample weight/solvent weight=0.1. The weights of the samples, which were left in the solvent medium, were monitored at 0.5, 1 and 2 hours on the first day, then at 24-hour intervals for a week and once a week in the following period. The dissolution rates of the glass samples were calculated using Equation 5.

$$DR = \frac{{W}_{i} - {W}_{s}}{A \times t} \qquad ( 5 )$$

According to the equation, DR is the dissolution rate, Wᵢ is the first weight of the sample, Wₛ is the last weight of the sample, A is the initial surface area of the sample, and t is the time during which it remains in the solution. During the dissolution of the samples, pH monitoring of the solvent medium was performed with a WTW Inolab pH/cond 720 model pH meter with an accuracy of 0.005. The pH changes in the solutions were monitored by taking measurements at certain intervals, at 24-hour intervals in the first week of dissolution, and once a week thereafter. In order to determine the amount of ions released from the glass sample over time during dissolution, two separate sets of experiments were created using different solvents. For two solvent media for which 2% citric acid solution and distilled water are used, at the end of the weeks 1, 2, 3 and 4, the amounts of ions that passed into the solution were determined by inductively coupled plasma—optical emission spectrometry (ICP-OES). Before the analysis performed using a Perkin Elmer Avio 200 model ICP-OES device, calibration was performed at 4 points using the standard solutions, and while a 100-fold dilution was applied for 2% citric acid solution before each measurement, no dilution was performed for distilled water. Pot experiments were carried out to examine the effect of the selected glass fertilizer composition on the growth of tomato plants. 4 different pot experiments, including the control sets, were set up. To this end, 4 cherry tomato seedlings were planted in pots of 3 liters. 1. The pot does not contain fertilizer, 2. The pot contains a glass fertilizer of the determined main composition, 3. The pot contains a glass fertilizer with a microelement additive, and 4. The pot contains a chemical fertilizer (NPK). The glass fertilizers with and without a microelement additive in the pot experiments were ground in a grain size range of 0.25-0.50 mm and mixed homogeneously with the soil, and the amount of the glass fertilizer was calculated according to the amount of the elements that the tomato plant absorbs during its development and to the results of the dissolution test of the determined glass fertilizer composition. However, each pot is illuminated by full spectrum led lamps used for plant growing, and the temperature and the humidity of the environment were monitored with a TT-Technic HTC-I clock moisture meter and thermometer. During plant development, the height of the seedlings was measured in weekly periods and the change in their height was recorded, and the fruit number, the weight, the average leaf size and the average stem thickness were determined.

In this section, the results of physical, thermal, structural analysis and the dissolution behavior of all glass samples produced in varying compositions in the P₂O₅— CaO—Na₂O—K₂O, P₂O₅—CaO—Al₂O₃— Na₂O—K₂O, P₂O₅— CaO—SiO₂— Al₂O₃— Na₂O—K₂O systems are given in detail.

The sample of P50C20K30 containing 50% P₂O₅, 20% CaO and 30% K₂O by mole was obtained as homogeneous, transparent and colorless at the end of the melting casting process. In order to determine the physical properties of the sample of P50C20K30, the density value was measured and determined to be 2.481 g/cm³. By using the density value obtained, the molar volume, the oxygen molar volume and the oxygen packing density of the sample were calculated and given in Table 4 together with the ratio of O/P.

TABLE 4
The values of density (ρ), molar volume
(V_{M}), oxygen molar volume (V_{O}) and oxygen
packing density (OPD) of the sample of P50C20K30

| | ρ | ρ_{Theoretical} | V_{M} | V_{O} | OPD |
|---|---|---|---|---|---|
| | (g/cm³) | (g/cm³) | (cm³/mol) | (cm³/mol) | (mol/L) |
| P50C20K30 | 2.481 | 2.523 | 44.52 | 15.35 | 67.39 |

The thermal characterization of the sample of P50C20K30 was carried out by a DTA analysis, and the analysis result is given in FIGS. 1A-1C. In the DTA thermogram obtained, an exothermic reaction was detected in addition to the glass transition reaction. As a result of the analysis, the values of glass transition, crystallization onset and peak temperature and the calculated value of thermal stability of the sample are given in Table 5.

TABLE 5
The values of glass transition (T_{g}), crystallization onset
and peak (T_{c}/Tₚ) and ΔT of the sample of P50C20K30

| | T_{g} (° C.) | T_{c} (° C.) | Tₚ (° C.) | ΔT (° C.) |
|---|---|---|---|---|
| P50C20K30 | 332 | 403 | 423 | 71 |

The result of the FTIR analysis performed for the structural characterization of the sample of P50C20K30 is given in FIG. 3. It was determined that the peak present in the spectrum at the wave number of 534 cm⁻¹ was caused by the bending vibration of the O═P—O or P—O—P bonds, while the weak peaks observed in the range of 600-800 cm⁻¹ were caused by the stretching vibration of the P—O—P bonds of the Q² unit. The peaks observed at the wave numbers of 872 cm⁻¹ and 1012 cm⁻¹ represent P—O—P bonds in linear and ring structures of the Q² unit. However, the peak observed at the wave number of 1083 cm⁻¹ is caused by the vibration of the PO₃⁻² group of the Q¹ structural unit, while the peaks at the wave numbers of 1174 and 1265 cm⁻¹ belong to the symmetrical and asymmetrical stretching vibration of the PO₂⁻ group of the Q² structural unit. In addition, it was determined that the peak observed at the wave number of 1336 cm⁻¹ was caused by the vibration of the P═O bond of the Q³ structural unit.

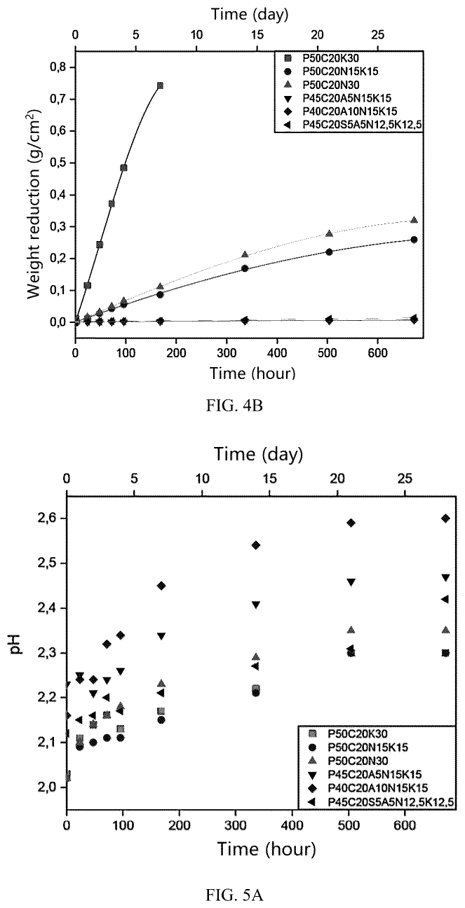

In order to determine the dissolution behavior of the sample of P50C20K30, the weight loss tracking carried out in two different media being distilled water and 2% citric acid solution, are given in FIGS. 4A-4B, respectively, the time dependent weight loss of the samples in citric acid on the left and in distilled water on the right. The average dissolution rates of the sample in both solvent media were calculated using the graphs obtained, it was determined to be 4.41E−03 g/cm²·s for distilled water and to be 6.13E-03 g/cm²·s for 2% citric acid solution, respectively.

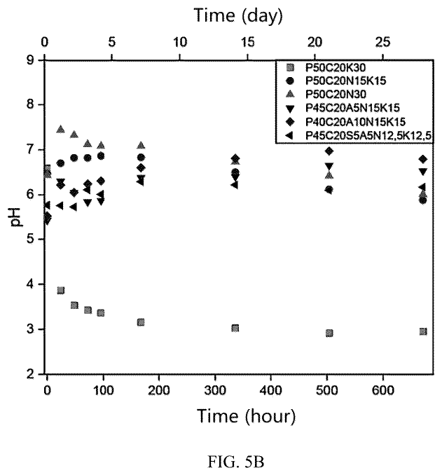

During the dissolution of the sample of P50C20K30, the pH changes in the solvents were monitored and the results obtained are given in FIGS. 5A-5B. During the dissolution of the sample of P50C20K30, the pH value of the 2% citric acid solution changed in the range of 2-2.3, and an increase in pH values was observed in the first stages of dissolution, but the pH of the solution remained at the level of 2.26±0.02 with the progression of dissolution. With the dissolution of the sample in distilled water, the pH value of the solvent reached 3.87 during the first 24 hours and shifted to the acidic region, and as time progressed, it was observed that the pH value remained at the level of 2.99±0.005.

The change in weight % of the sample of P50C20K30 in the distilled water and 2% citric acid solution by the weight change and the pH changes in the solvents are given in FIGS. 5A-5B. The sample of P50C20N15K5 was obtained as homogeneous, transparent and colorless as a result of the applied casting conditions.

In order to examine the physical properties of the sample of P50C20N15K15, the density thereof was measured, and the density value was determined to be 2.539 g/cm³. By using the measured density value, the values of molar volume, oxygen molar volume, oxygen packing density of the sample were calculated and given in Table 6 together with the determined O/P value.

TABLE 6
The values of density (ρ), molar volume
(V_{M}), oxygen molar volume (V_{O}) and oxygen packing
density (OPD) of the sample of P50C20N15K15

| | | | V_{M} | V_{O} | OPD |
|---|---|---|---|---|---|
| | ρ | ρ_{Theoretical} | (cm³/ | (cm³/ | (cm³/ |
| | (g/cm³) | (g/cm³) | mol) | mol) | mol) |
| P50C20K15N15 | 2.539 | 2.511 | 41.59 | 13.86 | 72.12 |

The result of the DTA analysis performed for the thermal characterization of the sample of P50C20N15K15 is given in FIG. 2. In the obtained thermogram, an exothermic peak was observed as well as the endothermic step change resulting from the glass transition reaction. As a result of DTA analysis, the values of glass transition, crystallization onset and peak were determined and the thermal stability value of the sample was calculated and given in Table 7.

TABLE 7
The values of glass transition (T_{g}), crystallization onset
and peak (T_{c}/Tₚ) and ΔT of the sample of P50C20N15K15

| | T_{g} (° C.) | T_{c} (° C.) | Tₚ (° C.) | ΔT (° C.) |
|---|---|---|---|---|
| P50C20N15K15 | 313 | 388 | 463 | 75 |

The result of the FTIR analysis performed for the structural characterization of the sample of P50C20N15K15 is given in FIG. 3. It was determined that the peak present in the spectrum at the wave number of 529 cm⁻¹ was caused by the bending vibration of the O═P—O or P—O—P bonds, while two weak peaks observed in the range of 600-800 cm⁻¹ were caused by the stretching vibration of the P—O—P bonds of the Q² unit. However, the peak observed at 872 cm⁻¹ and the shoulder formed at 981 cm⁻¹ are due to the stretching vibration of the P—O—P bonds in the linear and annular structure of the Q² structural unit. In addition, the peak observed at the wave number of 1087 cm⁻¹ is caused by the asymmetrical stretching vibration of the PO₃⁻² group of the Q¹ structural unit, while the intense peak formed at the wave number of 1280 cm⁻¹ belongs to the asymmetrical stretching vibration of the PO₂⁻ group of the Q² structural unit. The results of the weight loss examinations carried out in two different solvent media in order to examine the dissolution behavior of the sample of P50C20N15K15 are given in FIGS. 4A-4B. The average dissolution rates of the sample were determined to be 2.00E-04 g/cm²·s for distilled water and to be 1.43E-03 g/cm²·s for 2% citric acid solution.

During the dissolution of the sample of P50C20N15K15 in two different media, the pH of the solvents were followed, and the pH changes in citric acid on the left and distilled water on the right are given in FIGS. 5A-5B. During the dissolution of the sample in 2% citric acid solution, the solvent pH varied between 2.02-2.3. An increase was observed in the pH value of the solvent until 504th hour, and it was determined that the pH value remained constant at 2.3 in the following stages of the dissolution. For the dissolution in distilled water, the pH value of the solvent increased from 6.47 to 6.86 in the first 96 hours, a continuous decrease in the pH value was observed for the following 5 weeks and the pH values remained at the level of 5.67±0.024 in the following period.

The change in weight % of the sample of P50C20N15K15 in distilled water and 2% citric acid solution and the pH changes in the solvents are given in FIGS. 5A-5B.

As a result of the applied production conditions, the sample of P50C20N30 was obtained as homogeneous, transparent and colorless. In order to determine the physical properties of the sample of P50C20N30, the density thereof was measured, and the values of molar volume, oxygen molar volume and oxygen packing density were calculated. The obtained results are given in Table 8 along with the calculated O/P value of the sample.

TABLE 8
The values of density (ρ), molar volume
(V_{M}), oxygen molar volume (V_{O}) and oxygen packaging
density (OPD) of the sample of P50C20N15K15

| | ρ | ρ_{Theoretical} | V_{M} | V_{O} | OPD |
|---|---|---|---|---|---|
| | (g/cm³) | (g/cm³) | (cm³/mol) | (cm³/mol) | (cm³/mol) |
| P50C20N30 | 2.564 | 2.499 | 39.31 | 8.62 | 76.32 |

The result of the DTA analysis performed for the thermal characterization of the sample of P50C20N30 is given in FIG. 2. It was determined that the endothermic step change observed in the obtained thermogram was caused by the glass transition reaction, and in addition to that, an exothermic peak was observed. The values of glass transition, crystallization onset and peak temperature of the sample were determined and the value of thermal stability was calculated. The results obtained are given in Table 9.

TABLE 9
The values of glass transition (T_{g}), crystallization onset
and peak (T_{c}/Tₚ) and ΔT of the sample of P50C20N30

| | T_{g} (° C.) | T_{c} (° C.) | Tₚ (° C.) | ΔT (° C.) |
|---|---|---|---|---|
| P50C20N30 | 338 | 415 | 469 | 77 |

The result of the FTIR analysis performed for the structural characterization of the sample of P50C20N30 is given in FIG. 3. It was determined that the intense peak observed in the obtained spectrum at the wave number of 534 cm⁻¹ was caused by the bending vibration of the O═P—O or P—O—P bonds, while two weak peaks observed between the wave numbers of 600-800 cm⁻¹ represented the stretching vibration of the P—O—P bonds of the Q² structural unit. However, the peak formed at the wave number of 878 cm⁻¹ and the shoulder present at the wave number of 983 cm⁻¹ are due to the stretching vibration of the P—O—P bonds in the linear and annular structure of the Q² structural unit. In addition, the peak observed at the wave number of 1089 cm⁻¹ represents the asymmetrical stretching vibration of the PO₃⁻² group of the Q¹ structural unit, while the intense peak formed at the wave number of 1278 cm⁻¹ represents the asymmetrical stretching vibration of the PO₂⁻ group of the Q² structural unit.

The results of the weight loss examinations carried out in two different media in order to observe the dissolution behavior of the sample of P50C20N30 are given in FIGS. 4A-4B. By using the graphs obtained, the dissolution rates of the sample in both solvent media were calculated. The dissolution rate was determined to be 2.26E-04 g/cm²·s for distilled water and to be 3.25E-03 g/cm²·s for 2% citric acid solution.

During the dissolution of the sample of P50C20N30 in two different solvent media, the pH changes in the solvents were monitored and the results obtained are given in FIGS. 5A-5B. During the first 504 hours of dissolution in 2% citric acid solution, the pH of the solvent increased continuously, stabilized in the following stages and remained at the level of 2.34±0.0075. In the pH studies performed for distilled water, it was determined that the pH of the solvent increased during the first 24 hours, decreased continuously for the following 5 weeks, and then stabilized at the level of 6.04±0.022.

The change in weight % of the sample of P50C20N30 in the distilled water and 2% citric acid solution and the pH changes in the solvents are given in FIGS. 5A-5B.

During the melting process carried out during the production of the sample of P50C20M7.5N7.5K15, it was observed that the sample overflowed and many different methods were tested for the production of the sample. According to the determined production method, there was an increase to 700° C. at 10° C./min, a pre-heating process was applied at this temperature for 30 minutes, and the melting was carried out for 60 minutes again with an increase to 1275° C. at 10° C./min. XRF analysis of the sample obtained with the aforementioned production method was performed and the sample was compared to the determined glass blend composition. According to the results given in Table 10, it was determined that there was no significant deviation from the blend composition and that the applied production method was suitable for the production of the sample of P50C20M7.5N7.5K15.

TABLE 10
The blend composition of the sample of P50C20N7.5M7.5K15
and the results of XRF analysis

| | Weight % | | | | | | | | |
|---|---|---|---|---|---|---|---|---|---|
| | SiO₂ | Al₂O₃ | Fe₂O₃ | CaO | Na₂O | MgO | K₂O | P₂O₅ | Other |
| Blend Composition | — | — | — | 10.79 | 4.47 | 2.91 | 13.59 | 68.25 | — |
| Result of XRF Analysis | 0.21 | 0.04 | 0.02 | 13.3 | 4.82 | 1.88 | 14.6 | 65 | 0.13 |

Two different methods were tested for the production of the sample of P50C20M15K15. In the first production method, the prepared powder mixture was melted at 1275° C. for 30 minutes and poured into a preheated, stainless steel mold and subjected to stress relieving annealing at 350° C. for 3 hours. In the second production method, it was melted at 1275° C. for 1 hour and the obtained sample was ground and melted again at 1300° C. for 1 hour. After casting, the sample was subjected to the stress relief annealing at 350° C. for 3 hours. As a result of the applied production methods, the sample of P50C20M15K15 could not be obtained homogeneously. Since the sample could not be obtained homogeneously, a detailed study was not carried out on the change in the physical, thermal, structural properties and the dissolution behavior of the glasses of the P₂O₅— CaO—MgO—Na₂O—K₂O system.

The sample of P50C20A5N15K15 containing 45% P₂O₅, 20% CaO, 5% Al₂O₃, 15% Na₂O and 15% K₂O by mole was obtained as homogeneous, transparent and colorless as a result of the production method applied.

In order to examine the physical properties of the sample of P45C20A5N15K15, the density thereof was measured and the values of molar volume, oxygen molar volume and oxygen packing density were calculated. The obtained results are given in Table 11 along with the calculated O/P value of the sample.

TABLE 11
The values of density (ρ), molar volume
(V_{M}), oxygen molar volume (V_{O}) and oxygen packaging
density (OPD) of the sample of P45C20A5N15K15

| | | | V_{M} | V_{O} | OPD |
|---|---|---|---|---|---|
| | ρ | ρ_{Theoretical} | (cm³/ | (cm³/ | (cm³/ |
| | (g/cm³) | (g/cm³) | mol) | mol) | mol) |
| P45C20A5N15K15 | 2.629 | 2.593 | 39.41 | 13.59 | 73.57 |

The result of the DTA analysis performed in order to determine the thermal properties of the sample is given in FIG. 2. It was determined that the endothermic step change observed in the obtained thermogram was caused by the glass transition reaction, and the glass transition temperature value was determined to be 376° C. No exothermic peaks were observed in the temperature range at which the analysis was carried out.

The result of the FTIR analysis performed for the structural characterization of the sample of P45C20A5N15K15 is given in FIG. 3. It was determined that the peak observed at the wave number of 534 cm⁻¹ in the obtained spectrum was caused by the bending vibration of the O═P—O or P—O—P bonds, while the weak peaks formed at the wave numbers of 710 cm⁻¹ and 750 cm⁻¹ were caused by the vibration of the P—O—P bonds in the P₂O₆⁻² group in the metaphosphate chains. However, it was determined that the peaks observed at the wave numbers of 883 cm⁻¹ and 980 cm⁻¹ were caused by the vibration of the P—O—P bonds in the linear and annular structure of the Q² structural unit. In addition, the peak formed at the wave number of 1103 cm⁻¹ represents the asymmetrical stretching vibration of the PO₃⁻² group of the Q¹ structural unit, while the peaks observed at the wave numbers of 1184 cm⁻¹ and 1263 cm⁻¹ represent the symmetrical and asymmetrical stretching vibration of the PO₂⁻ group of the Q² structural unit.

The result of the weight loss examinations carried out in two different solvent media in order to examine the dissolution behavior of the sample of P45C20A5N15K15 is given in FIGS. 4A-4B. The average dissolution rate of the sample in two solvent media was calculated using the results obtained and determined to be 7.89E-06 g/cm²·s for distilled water and to be 3.40E-04 g/cm²·s for 2% citric acid solution.

During the dissolution of the sample took place in two different solvent media, the pH values of the solvents were monitored, and the results are given in FIGS. 5A-5B. During dissolution took place in 2% citric acid solution, the pH of the solvent increased from 2.23 to 2.6, and the observed increase slowed down after 336th hour of the dissolution. During the dissolution of the sample in distilled water, the pH of the solvent increased until 508th hour and after then was observed to remain at the level of 6.57±0.0302.

The change in weight % of the sample of P45C20A5N15K15 in the distilled water and 2% citric acid solution and the pH changes in the solvents are given in FIGS. 5A-5B.

The sample of P40C20AlON15K15 was obtained as homogeneous, transparent and colorless under the applied production conditions.

In order to examine the physical properties of the sample, the density measurement was carried out, and the values of molar volume, oxygen molar volume and oxygen packing density were calculated. The results obtained are given in Table 12.

TABLE 12
The values of density (ρ), molar volume
(V_{M}), oxygen molar volume (V_{O}) and oxygen packing
density (OPD) of the sample of P40C20A10N15K15

| | | | V_{M} | V_{O} | OPD |
|---|---|---|---|---|---|
| | ρ | ρ_{Theoretical} | (cm³/ | (cm³/ | (cm³/ |
| | (g/cm³) | (g/cm³) | mol) | mol) | mol) |
| P40C20A10N15K15 | 2.672 | 2.676 | 38.03 | 13.58 | 73.62 |

The result of the DTA analysis performed in order to determine the thermal properties of the sample of P40C20AlON15K15 is given in FIG. 2. It was determined that the endothermic step change observed in the obtained thermogram was caused by the glass transition reaction. The specified value of the glass transition temperature was determined to be 446° C., and no exothermic peaks were observed in the temperature range at which the analysis was carried out. The result of the FTIR analysis performed in order to determine the structural properties of the samples is given in FIG. 3. In the obtained spectrum, it was determined that the peak observed at the wave number of 533 cm⁻¹ was caused by the vibrations of the O═P—O or P—O—P bonds, and the peak at the wave number of 545 cm⁻¹ was caused by the vibration of the octahedral AlO₆ group. The peaks observed at the wave numbers of 740 cm⁻¹ and 900 cm⁻¹ are caused by the vibrations of the P—O—P bonds in the P₂O₇⁴⁻ pyrophosphate group and the P—O—P bonds of the Q² structural unit, respectively. However, it was determined that the peak observed at the wave number of 1041 cm⁻¹ was caused by the asymmetrical vibration of the P—O—P bonds in the annular structure of the Q² structural unit. The peaks observed at wave numbers of 1115 cm⁻¹ and 1284 cm⁻¹ are caused by the asymmetric stretching vibration of the PO₃⁻² group of the Q¹ structural unit and the symmetrical vibration of the PO₂⁻ group of the Q² structural unit, respectively.

In order to examine the dissolution behavior of the sample of P40C20AlON15K15, the weight loss tracking was performed in two different solvent media, and the results are given in FIGS. 4A-4B. The average dissolution rates of the sample were determined to be 4.79E-06 g/cm²·s for distilled water and to be 4.63E-04 g/cm²·s for 2% citric acid solution.

During the dissolution of the sample took place in two different solvent media, the pH values of the solvents were monitored and the results are given in FIGS. 5A-5B. During dissolution took place in 2% citric acid solution, the pH of the solvent increased from 2.16 to 2.79, and the observed increase slowed down after 336th hour of the dissolution. During the dissolution of the sample in distilled water, the pH of the solvent increased until 504th hour and after then stabilized and remained at 6.94±0.02.

The change in weight % of the sample of P40C20AlON15K15 in the distilled water and 2% citric acid solution and the pH changes in the solvents are given in FIGS. 5A-5B.

The sample of P45C20S5A5N12.5K12.5 was obtained as homogeneous, transparent and colorless under the applied production conditions.

XRF analysis of the sample obtained was performed, and the sample was compared to the determined glass blend composition. According to the results given in Table 13, it was determined that the amount of P₂O₅ obtained as a result of the analysis was lower than the amount in the blend composition depending on the melting conditions, while CaO and K₂O amounts were higher than those in the composition due to the normalization of the analysis results according to the new P₂O₅ amount obtained.

TABLE 13
The blend composition of the sample of P50C20S5A5N12.5K12.5 and the results of XRF analysis

| | Weight % | | | | | | | | | | |
|---|---|---|---|---|---|---|---|---|---|---|---|
| | SiO₂ | Al₂O₃ | Fe₂O₃ | CaO | Na₂O | MgO | K₂O | P₂O₅ | SO₃ | TiO₂ | Others |
| Blend Composition | 2.93 | 4.96 | — | 10.92 | 7.54 | — | 11.46 | 62.19 | — | — | — |
| Result of XRF Analysis | 3.03 | 4.19 | 0.07 | 16.3 | 6.61 | 0.14 | 13.7 | 55.6 | 0.13 | 0.09 | 0.13 |

In order to examine the physical properties of the sample, the density thereof was measured and the values of molar volume, oxygen molar volume and oxygen packing density were calculated. The results obtained are given in Table 14.

TABLE 14
The values of density (ρ), molar volume
(V_{M}), oxygen molar volume (V_{O}) and oxygen packing
density (OPD) of the sample of P45C20S5A5N12.5K12.5

| | | | V_{M} | V_{O} | OPD |
|---|---|---|---|---|---|
| | ρ | ρ_{Theoretical} | (cm³/ | (cm³/ | (cm³/ |
| | (g/cm³) | (g/cm³) | mol) | mol) | mol) |
| P45C20S5A5N12.5K12.5 | 2.595 | 2.611 | 39.58 | 13.42 | 74.53 |

The result of the DTA analysis performed in order to examine the thermal properties of the sample of P45C20S5A5N12.5K12.5 is given in FIGS. 1A-1C. It was determined that the endothermic step change observed in the obtained thermogram was caused by the glass transition reaction, and the glass transition temperature for the sample of P45C20S5A5N12.5K12.5 was determined to be 400° C. No exothermic peaks were observed in the temperature range at which the analysis was carried out.

The result of the FTIR analysis performed for the structural characterization of the sample of P45C20S5A5N12.5K12.5 is given in FIG. 4.33. In the spectrum obtained, it was determined that the shoulder formed at the wave number of 499 cm⁻¹ was caused by the bending vibration of the Si—O—Si and Si—O—P bonds, while the peak observed at the wave number of 533 cm⁻¹ was caused by the vibrations of the O═P—O or P—O—P bonds. It was determined that the weak peaks at the wave numbers of 721 cm⁻¹ and 764 cm⁻¹ were caused by the vibration of the P—O—P bonds in the P₂O₆⁻² group in the metaphosphate chains. However, it was determined that the peaks observed at the wave numbers of 892 cm⁻¹ and 987 cm⁻¹ were caused by the vibration of the P—O—P bonds in the linear and annular structure of the Q² structural unit. In addition, the peak formed at the wave number of 1098 cm⁻¹ represents the asymmetrical stretching vibration of the PO₃⁻² group of the Q¹ structural unit, while the peaks observed at the wave numbers of 1192 cm⁻¹ and 1262 cm⁻¹ represent the symmetrical and asymmetrical stretching vibration of the PO₂⁻ group of the Q² structural unit.

In order to examine the dissolution behavior of the sample, the weight loss tracking was performed in two different solvent media and the results are given in FIGS. 4A-4B. The average dissolution rate of the sample in two different solvent media was determined to be 1.49E-05 g/cm²·s for distilled water and to be 3.10E-04 g/cm²·s for 2% citric acid solution.

During the dissolution of the sample took place in two different solvent media, the pH values of the solvents were monitored and the results are given in FIGS. 5A-5B. During dissolution took place in 2% citric acid solution, the pH of the solvent increased from 2.12 to 2.43. During the dissolution of the sample in distilled water, it was observed that the solvent pH increased up to 6.29 in the first 168 hours and decreased in the following period.

The change weight % of the sample of P45C20S5A5N12.5K12.5 in the distilled water and 2% citric acid solution and the pH changes in the solvents are given in FIGS. 5A-5B.

The amounts of P, Ca, Si, Al, Na and K which passed into the solvent medium depending on time during the dissolution of the sample of P45C20S5A5N12.5K12.5 in 2% citric acid solution and distilled water were determined by ICP-OES, and the results are shown in FIGS. 4A-4B.

When the results were examined, it was determined that the amounts of P, Ca, Si, Al, Na and K increased over time during the dissolution of the sample of P45C20S5A5N12.5K12.5 in distilled water. During the dissolution in 2% citric acid solution, it was observed that the amounts of P, Ca, Si, Al, Na and K, which passed into the solvent during the first 3 weeks, increased over time, but when the results of the 3rd and 4th weeks were compared, it was observed that for each element, there was a passage into solution in proximate proportions. It was determined that this case may be due to the slowing down of the dissolution depending on the increase in the solvent concentration.

The sample of P45C20S5A5N12.5K12.5-M was obtained as homogeneous, transparent and green under the applied production conditions.

In order to examine the physical properties of the sample, the density measurement was carried out, and the values of molar volume, oxygen molar volume and oxygen packing density were calculated. The results obtained are given in Table 15.

TABLE 15
The values of density (ρ), molar volume
(V_{M}), oxygen molar volume (V_{O}) and oxygen packing
density (OPD) of the sample of P45C20S5A5N12.5K12.5-M

| | | | V_{M} | V_{O} | OPD |
|---|---|---|---|---|---|
| | ρ | ρ_{Theoretical} | (cm³/ | (cm³/ | (cm³/ |
| | (g/cm³) | (g/cm³) | mol) | mol) | mol) |
| P45C20S5A5N12.5K12.5-M | 2.620 | 2.654 | 39.46 | 13.41 | 74.59 |

The spectrum obtained as the result of the FTIR analysis performed for the structural characterization of the sample of P45C20S5A5N12.5K12.5-M is given in FIG. 3. It was determined that the peak observed at the wave number of 507 cm⁻¹ in the obtained spectrum was caused by the vibration of the P—O—P bonds, while the weak peaks observed at 744 and 761 cm⁻¹ were caused by the vibration of the P—O—P bonds in the P₂O₆⁻² group. It was determined that the peaks observed at the wave numbers of 902 cm⁻¹ and 983 cm⁻¹, respectively were caused by the vibration of the P—O—P bonds in the linear and annular structure of the Q² structural unit. However, the peak formed at the wave number of 1097 cm⁻¹ represents the asymmetrical stretching vibration of the PO₃⁻² group of the Q¹ structural unit, while the peaks observed at the wave numbers of 1195 cm⁻¹ and 1253 cm⁻¹ represent the symmetrical and asymmetrical stretching vibration of the PO₂⁻ group of the Q² structural unit.

The spectrum obtained as the result of the DTA analysis performed in order to determine the thermal properties of the sample of P45C20S5A5N12.5K12.5-M is given in FIG. 2. When the obtained thermogram was examined, the glass transition temperature was determined to be 402° C., and no exothermic peaks were observed in the temperature range at which the analysis was carried out.

The dissolution behavior of the sample of P45C20S5A5N12.5K12.5-M with a microelement additive was not investigated and this sample was used directly in the pot experiments.

The results of physical, thermal, structural analysis and the dissolution behavior of the glass samples of the P₂O₅— CaO—Na₂O—K₂O, P₂O₅— CaO—Al₂O₃— Na₂O—K₂O, P₂O₅— CaO—SiO₂— Al₂O₃— Na₂O—K₂O systems are evaluated respectively according to the varying Na₂O/Na₂O+K₂O, Al₂O₃/P₂O₅ and SiO₂/Na₂O+K₂O composition, and the effect of the glasses with and without additives, which were determined to be suitable for the development of a tomato plant, on the development of tomato plant was interpreted.

The values of densities, theoretical densities, molar volume, oxygen molar volume and oxygen packing density of the glass samples obtained in the P₂O₅— CaO—Na₂O—K₂O system, which were measured for the purpose of examining the physical properties, are given in Table 16, and the changes in the values of density, molar volume, oxygen molar volume and oxygen packing density according to the varying ratio of Na₂O/Na₂O+K₂O in the composition are shown in FIG. 5A.

TABLE 16
The values of density (ρ), molar volume (V_{M}), oxygen molar volume (V_{O})
and oxygen packing density (OPD) of the samples of glass
obtained in P₂O₅—CaO—Na₂O—K₂ system

| | ρ | ρ_{Theoretical} | V_{M} | V_{O} | OPD |
|---|---|---|---|---|---|
| Sample | (g/cm³) | (g/cm³) | (cm³/mol) | (cm³/mol) | (mol/L) |
| P50C20K30 | 2.48 | 2.52 | 44.52 | 15.35 | 67.39 |
| P50C20K15N15 | 2.54 | 2.51 | 41.59 | 13.86 | 72.12 |
| P50C20N30 | 2.56 | 2.50 | 39.31 | 8.62 | 76.32 |

When the results are examined, it is seen that the theoretical density decreases as the ratio of K₂O in the structure decreases and the ratio of Na₂O increases. This is caused by the fact that the density of K₂O (2.35 g/cm³) is slightly higher than that of Na₂O (2.27 g/cm³). However, when the experimentally obtained density results were examined, it was determined that the density increased as the ratio of K₂O in the structure decreases. This difference between the theoretical and measured densities can be understood by the difference between the radii, densities and values of electronegativity of the alkali ions. The radius of the K⁺ ion (1.38 Å) is larger (1.02 Å) than the Na⁺ ion, and accordingly the K⁺ ion density (0.862 g/cm³) is lower than the Na⁺ ion density (0.971 g/cm³). In addition, the electronegativity value of the K⁺ ion (0.82) is lower than the Na⁺ ion (0.93), which causes a looser network structure. Therefore, as the ratio K₂O in the composition decreases, a decrease in the molar volume values occurs.

It was determined that the oxygen molar volume values decreased with the decreasing ratio of K₂O/Na₂O+K₂O in the structure. This is caused by the tighter packing of the structure as a result of the replacement of the K⁺ ion with lower field strength (0.13) by the Na⁺ (0.17) ion with higher field strength.

On the other hand, the oxygen packing densities of the glasses increased with the decrease of the ratio of K₂O/Na₂O+K₂O, in contrast to the V_{O} values. It was determined that an increase in OPD values resulted from the formation of a more tightly packed structure by the replacement of the K⁺ ion by the Na⁺ ion with higher field strength, considering that the total number of oxygen possessed by each sample composition is the same.

The thermal stability values calculated with the values of glass transition, crystallization onset and peak temperature determined to be a result of the thermal analysis of the glass samples of the P₂O₅— CaO—Na₂O—K₂O system are given in Table 17.

TABLE 17
The values of glass transition (T_{g}), crystallization onset
and peak (T_{c}/Tₚ) and ΔT obtained as a result of thermal analysis of glass
samples of the P₂O₅—CaO—Na₂O—K₂O system

| Sample | T_{g} (° C.) | T_{c} (° C.) | Tₚ (C) | ΔT (° C.) |
|---|---|---|---|---|
| P50C20K30 | 332 | 403 | 423 | 71 |
| P50C20N15K15 | 313 | 388 | 463 | 75 |
| P50C20N30 | 338 | 415 | 469 | 77 |

When the results are examined, although there is not a significant difference between the T_{g} values for the samples of P50C20K30 and P50C20N30, it is seen that the sample containing 30% Na₂O by mol has a higher T_{g} value than the sample containing 30% K₂O. This is caused by the looser structure of the sample of P50C20K30, as the K⁺ ion has a larger ionic radius and a lower field strength than the Na⁺ ion. Theoretically, while the ratio of K₂O in the structure increases and the ratio of Na₂O decreases, the amount of NBO will increase as the P—O—P bonds are broken, and this will cause a decrease in T_{g} values. However, when the results obtained were examined, no linear change was observed in the T_{g} values with the increase in the amount of Na₂O in the composition, and the lowest T_{g} value was obtained for the sample containing 15% Na₂O by mole. This non-linear behavior observed at the transition temperatures of the samples with the increasing ratio of Na₂O in the structure is a result of the mixed alkali effect (MAE). The mixed alkali effect represents a behavior of change in the properties (ionic diffusion, ionic conductivity, dielectric relaxation, glass transition temperature, viscosity etc.) of the glass depending on the structure and ion movement, as a result of the gradual replacement of an alkali ion in the structure by another alkali ion in multi-component glass systems, and this change does not show linearity with the change in the composition. The negative deviation from linearity observed at the glass transition temperatures, which occurs with MAE, is explained by a defect model proposed by LaCourse in the literature. According to this model, in the mixed alkali-containing glasses, M-O-M (M: network former cation) bonds are broken as a result of the reorganization of the ionic regions together with the jump of ions to foreign regions. This situation shifts T_{g} values towards lower temperatures by increasing the breakdown of the network structure and the formation of structural errors.

The thermal stability values of the glass samples varied between 71 and 77° C. and showed an increase with the increasing ratio of Na₂O.

FTIR spectra of the samples of glass in the range of 400-1400 cm⁻¹ are given in FIG. 3 comparatively. As a result of the calculations, it was determined that the O/P value was equal for all compositions and O/P was determined to be 3. This indicates that theoretically the Q² unit will be dominant in the structure.

The properties of the vibrations observed in the spectra were determined by reviewing the literature data, and when the spectra obtained were examined, 3 strong peaks were observed for each sample. The peak around 530 cm⁻¹ represents O═P—O or P—O—P bonds, while the peaks observed around˜880 cm⁻¹ and ˜1280 cm⁻¹ represent the P—O—P bonds and PO₂⁻ group of the Q² structural unit, respectively. This shows that all samples obtained in the P₂O₅—CaO—Na₂O—K₂O system have a structure dominated by the Q² unit, and this result is also consistent with the O/P values calculated for the samples.

The peaks observed between the wave numbers of 640 cm⁻¹-780 cm⁻¹ are caused by the vibrations of P—O—P bonds. While there were 3 peaks in this region for the sample containing 30% K₂O by mole, the peak at wave number of 648 cm⁻¹ disappeared with the addition of Na₂O to the structure. In addition, with the increasing ratio of Na₂O, it was determined that the shoulder observed at the wave number of ˜1012 cm⁻¹, which represents the P—O—P bond, was shifted towards the wave number of ˜983 cm⁻¹. It was determined that this situation was caused by the increase in the P—O—P bond.

The peaks observed at 1083 cm⁻¹ and 1265 cm⁻¹ are caused by the vibrations of the PO₃⁻² group of the Q¹ structural unit and the PO₂⁻ group of the Q² structural unit, respectively, and the intensities of the peaks show a nonlinear change with the increasing ratio of Na₂O. However, it was observed that the peak observed at 1174 cm⁻¹ and caused by the symmetrical vibration of the PO₂⁻ group of the Q² structural unit was shifted to lower wavelengths with the increasing ratio of Na₂O. Furthermore, in the spectrum of the sample of P50C20K30, it is seen that the peak caused by the vibration of the P═O bond of the Q³ structural unit observed at 1336 cm⁻¹ disappears with the increasing ratio of Na₂O in the structure. In the literature, the fact that Q² and Q¹ structural units can be observed and Q³ units cannot be observed in the samples with the varying ratios of CaO/Na₂O in the constant P₂O₅ composition is explained by the effect of the melting process on the glass structure. It was indicated that this difference in the glass structure may have resulted in the reduction of cross-links in the glass structure as a result of phosphate losses during melting, and this may have resulted in the lack of the Q³ unit in the structure.

The bandwidth is related to the specific variety of bond angles, bond lengths, and coordination types of charge-balancing cations. When the FTIR analyzes of the glass samples of the P₂O₅—CaO—Na₂O—K₂O system were evaluated in general, it was determined that there were changes in the intensities and positions of the peaks depending on the varying composition, and that with the increasing ratio Na₂O/Na₂O+K₂O, a non-linear change occurred in the peak intensities and the band widths of the PO₃⁻² group of the Q¹ structural unit and the PO₂⁻ group of the Q² structural unit. This nonlinear variation observed for the non-bonding oxygen is a result of MAE. Na⁺ ion tends to exist in the NBO regions by creating regions of certain diameter with a certain coordination with the non-bonding oxygen (NBO) within the structure. On the other hand, K⁺ ions have a different NBO coordination and create larger regions. At low temperatures, although most K⁺ ions will be located in the potassium regions and most Na⁺ ions will be located in the sodium regions, some of the cations in the structure will be located in the other cation region. This situation is caused by the mixed alkaline effect.

The time-dependent weight loss behavior of the glass samples obtained in the P₂O₅— CaO—Na₂O—K₂O system in 2% citric acid solution and distilled water are given in FIGS. 5A-5B along with the calculated average dissolution rates.

When the data obtained were examined, it was seen that the fastest dissolution was occurred for the sample containing 30% K₂O by mole in both media, that the dissolution rate was the lowest observed with the addition of 15% Na₂O to the composition, and that a slight increase occurred in the dissolution rate once Na₂O completely replaced K₂O.

The rapid dissolution of the sample of P50C20K30 in both media is caused by the fact that the K⁺ ion with low field strength and large ion radius lead to a looser glass structure. On the other hand, it is observed that the dissolution of the sample of P50C20N30 is slower than the sample containing 30% K₂O by mole. This is a result of Na⁺, which has a smaller ionic radius and higher electronegativity, forming a tighter network.

It was determined that the slowest dissolution was observed for the sample of P50C20N15K15, and that there was a negative deviation from linearity in the change of the chemical resistance property of the glass with the composition in this sample. This situation is thought to be a result of mixed alkaline effect. In the literature, many models have been focused on to explain the mixed alkali effect. Maas et al. demonstrated a dynamic structure model by showing the formation of energy mismatch in the cation regions and the effect thereof on the ion transport. According to this model, a drastic decrease in the ion mobility of the glasses which contain mixed alkali occurs as a result of the effective inhibition of ion conduction pathways due to the region mismatch. The random ion distribution model, which is consistent with the dynamical structure model, similarly states that the ions retain their local regions relative to the glass which contains a single modifier, leading to a mismatch between different ion regions, thus reducing the number of regions available for the ion migration.

In accordance with the results obtained, it was determined that all samples showed a similar trend in both neutral and acidic media, and it was observed that the samples in 2% citric acid solution showed a faster dissolution behavior compared to distilled water. The rapid dissolution behavior of the samples in 2% citric acid solution with a low pH value is the result of the acceleration of the hydration reaction, which is one of the effective reactions in the dissolution mechanism of phosphate glasses, with the increase of H+ ion concentration.

The pH changes of the glass samples obtained in the P₂O₅— CaO—Na₂O—K₂O system during their dissolution in the 2% citric acid solution and distilled water media are given in FIGS. 5A-5B.

When the pH changes in the citric acid solution are examined, it was observed that the pH change occurred in a very limited range, and it was determined that the pH value of the solution increased in the first stages of the dissolution and did not change significantly in the following stages. The dissolution process starts and continues with the reaction of H₂O, OH⁻, H⁺ (or H₃O⁺) at the glass-solvent interface. Hydration and hydrolysis reactions play an active role in the dissolution of the glass samples. With the hydration reaction, the hydrogen ions in the solution replace the mobile ions in the network structure and form a hydrated layer at the glass-solvent interface. The P—O—P bonds are broken as a result of the breakdown of this hydrate layer formed by the hydrolysis reaction. During the dissolution in 2% citric acid solution, the H+ ions in the solution began to be depleted in accordance with the hydration reaction, and consequently, an increase in the pH values of the solutions was observed in the early stages of the dissolution. In the following stages of dissolution, the ratio of H⁺ ion consumed decreased considerably. It is known in the literature that reaching an increase in the concentration of the groups that pass from the glass structure to the solution, a level sufficient to form a buffer solution after a certain point can have a similar effect on the pH value. The fact that the pH values observed for all samples did not change in the following hours in FIGS. 5A-5B is thought to be caused by the formation of the buffer solution.

When the effects of the samples dissolved in distilled water on the pH value of the solution were examined, it was observed that the pH value of the sample of P50C20K30 suddenly decreased to the acidic region (˜3.0). This is the result of a rapid dissolution due to the loose network structure formed by K⁺ ion with a large ion radius. It is thought that this sudden decrease in pH value is due to the rapid increase in HPO₄ and PO₄⁻³ concentrations in the solution as a result of the rapid dissolution behavior. For the samples of P50C2ON15K15 and P50C20N30, which showed a slower dissolution behavior, an increase in the pH values was observed at the beginning of the dissolution as a result of the consumption of H⁺ ions in the solution in accordance with the hydration reaction. In the following stages, as a result of the hydrolysis reaction, the P—O—P bonds are broken and the P—OH⁻ group is formed. The formed P—OH⁻ group can be deprotonated depending on the pH of the solution. Therefore, with the hydrolysis reaction, the H+ ion concentration in the solution increases and the pH value decreases. At the following stages of the dissolution, the pH values for all samples remain at an almost constant value. It is thought that this situation arises from the fact that the solution acts as a buffer solution after a certain point with an increase in the ion concentration in the solution.

The measured values of densities, theoretical densities, molar volume, oxygen molar volume and oxygen packing density of the glass samples synthesized in the P₂O₅— CaO—Al₂O₃— Na₂O—K₂O system are given in Table 18 for the purpose of examining the physical properties. The change in density, molar volume, oxygen molar volume and oxygen packing density depending on the Al₂O₃/P₂O₅ contents of the samples is shown in FIGS. 1A-1C.

TABLE 18
The values of density (ρ), molar volume (V_{M}), oxygen molar volume (V_{O})
and oxygen packing density (OPD) of the samples of glass
obtained in P₂O₅—CaO—Al₂O₃—Na₂O—K₂O system

| | | | V_{M} | V_{O} | |
|---|---|---|---|---|---|
| | ρ | ρ_{Theoretical} | (cm³/ | (cm³/ | OPD |
| Sample | (g/cm³) | (g/cm³) | mol) | mol) | (mol/L) |
| P45C20A5N15K15 | 2.63 | 2.59 | 39.41 | 13.59 | 73.57 |
| P40C20A10N15K15 | 2.67 | 2.68 | 38.03 | 13.58 | 73.62 |

The measured densities of the obtained samples are compatible with the calculated theoretical densities of the glasses, and it is observed that the density values of the samples increase with the replacement of P₂O₅ in the structure at a constant alkaline earth and alkaline oxide concentration, by Al₂O₃, which has a higher density. However, a decrease in molar volume was observed with the increase of Al₂O₃ amount in the structure. This is due to the lower molar mass and the higher density of Al₂O₃ compared to P₂O₅.

When the oxygen molar volumes of the samples were examined, no significant change was observed in the values of the oxygen molar volume with the increasing amount of Al₂O₃. It was observed that the oxygen packing densities increased slightly with the increasing Al₂O₃ ratio, since Al⁺³ (0.84) ion with a high field strength formed cross-links in the structure and made the structure tighter. This situation is caused by the fact that the Al⁺³ ion creates a more tightly packed structure by increasing the cross-links in the structure.

The thermograms obtained as a result of the thermal analysis of the glass samples of the P₂O₅—CaO—Al₂O₃—Na₂O—K₂O system are given in FIG. 2, and in the range of 25-500° C. where DTA analysis was performed, only the glass transition reactions were detected, and no crystallization peak was observed. Therefore, the thermal stability values of the obtained samples could not be determined.

As a result of the DTA analysis, it was determined that the transition temperature increased from 376° C. to 446° C. with the increase of the ratio of Al₂O₃/P₂O₅. When the Al⁺³ ion having a high field strength enters the structure, it forms cross-links with the phosphate chains, and P—O—P bonds in the structure are replaced with stronger covalent P—O—Al bonds. This situation causes an increase in the glass transition temperature with an increasing ratio of Al₂O₃.

The FTIR spectra of the glass samples synthesized in P₂O₅—CaO—Al₂O₃—Na₂O—K₂O system are given in FIG. 3. However, the O/P values of the samples were calculated, and it was determined that this value increased from 3.2 to 3.5 with an increasing ratio of Al₂O₃/P₂O₅. O/P=3.2 for the sample containing 5% Al₂O₃ by mole indicates that Q² and Q¹ units are dominant in the structure, while O/P=3.5 for the sample containing 10% Al₂O₃ by mole indicates that Q¹ units have become more dominant in the structure. Therefore, it is predicted that the small phosphate groups in the structure will increase with the increase of the ratio of Al₂O₃/P₂O₅.

When the obtained spectra were examined, it was determined that the peak around 533 cm⁻¹ represented O═P—O or P—O—P bonds, and as a result of increasing the ratio of Al₂O₃ to 10% by mole, a new peak formation was observed at the wave number of ˜545 cm⁻¹. This peak is caused by the vibration of the octahedral AlO₆ group.

The peaks observed in the wave number range of 720-780 cm⁻¹ are caused by the vibrations of the P—O—P bonds in the P₂O₆²⁻ group in the metaphosphate chains. For the sample containing 5% Al₂O₃ by mole, two weak peaks were observed in this region, as a result of the increase in the amount of Al₂O₃, the peak at the wave number of ˜710 cm⁻¹ disappeared, while the peak at the wave number of ˜757 cm⁻¹ was shifted to ˜744 cm⁻¹. According to the literature, the peak observed at the wave number of ˜740 cm⁻¹ is caused by the vibrations of the P—O—P bonds in the P₂O₇⁴⁻ pyrophosphate group. This change observed in the spectrum is the result of the depolymerization of the (P₂O₆²⁻)_{∞} group, and the formation of the short phosphate groups such as P₂O₇⁴⁻ and PO₄³⁻ results from a gradual breaking of the endless chains in the metaphosphate glass structure with the increase of the ratio of Al₂O₃/P₂O₅.

It was observed that the peak at the wave number of 883 cm⁻¹, which was caused by the vibrations of the P—O—P chains of the Q² structural group, was shifted to the wave number of 900 cm⁻¹ with an increasing ratio of Al₂O₃. However, the shoulder which is observed at 980 cm⁻¹ for the sample containing 5% Al₂O₃ by mole and which is observed due to the P—O—P bonds that form the wide annular structures of the Q² structural unit, was shifted to the region (1041 cm⁻¹) where the peaks caused by the vibrations of the PO₃⁻² group of the Q¹ structural unit were observed, with the increase of the ratio of Al₂O₃/P₂O₅.

It was determined that the peak formed at the wave number of 1103 cm⁻¹ and caused by the asymmetric stretching vibration of the PO₃⁻² group of the Q¹ structural unit was shifted to a higher wavelength (1115 cm⁻¹) with an increasing ratio of Al₂O₃, and it was detected that the intensity of the peak, which is present at 1184 cm⁻¹ and caused by the symmetrical vibration of the PO₂⁻ group of the Q² structural unit, increased with an increasing amount of Al₂O₃. However, it was observed that the peak, which is observed at the wave number of 1263 cm⁻¹ and represents the PO₂⁻ group of the Q² structural unit, disappeared with an increasing ratio of Al₂O₃/P₂O₅. It is thought that these changes observed in the obtained spectra may be a result of the replacement of P—O—Al bonds with P—O—P bonds, with Al₂O₃ replacing P₂O₅, and of the decrease in the phosphate chain lengths of the Al⁺³ ion with high field strength entering the structure at an increasing ratio of O/P.

The data obtained from the weight loss examinations of the glass samples synthesized in the P₂O₅—CaO—Al₂O₃—Na₂O—K₂O system in 2% citric acid solution and distilled water medium, are given in FIGS. 4A-4B along with the calculated average ratio of the dissolution.

When the results obtained are examined, as the H⁺ concentration is higher in the acidic solution, the hydration reaction takes place more effectively, and the dissolution occurs faster than in distilled water.

Theoretically, as a result of the increase of the ratio of Al₂O₃/P₂O₅, it is expected that the Al⁺³ ion will form strong cross-links between the phosphate chains and that there is an increase in the chemical resistance as smaller phosphate groups replace the longer phosphate chains, which are more sensitive to hydration, with an increasing ratio of O/P. However, when the experimental results were examined, the sample containing 10% Al₂O₃ by mole in 2% citric acid solution showed a faster dissolution behavior. In distilled water, while the sample containing 10% Al₂O₃ by mole showed a faster dissolution during the first month, the sample containing 5% Al₂O₃ by mole dissolved faster in the following stages. This situation, which is inconsistent with the theoretically expected results, can be explained by the AlOₓ groups in the structure. Al₂O₃ can be found in 3 different forms as AlO₆, AlO₅ and AlO₄ depending on the coordination number in the structure. The average Al—O coordination number varies depending on the ratio of O/P. With the increasing ratio of O/P, the Al—O coordination number decreases, while the ratio of AlO₆ in the structure decreases and the ratios of AlO₅ and AlO₄ increase. The fact that the AlO₅ structural group is not as stable as AlO₆ and AlO₄ causes a decrease in the chemical resistance as a result of the increase in the amount of this group in the structure. It is thought that the time-dependent change in the dissolution behavior is caused by the change in the ratio of AlOₓ groups in the structure.

The changes in the pH value of the solvent during the dissolution of the glass samples obtained in the P₂O₅—CaO—Al₂O₃—Na₂O—K₂O system in 2% citric acid solution and distilled water medium are given in FIGS. 5A-5B.

When the results obtained were examined, it was observed that both samples increased the pH value of 2% citric acid solution and distilled water medium in the first stages of the dissolution. This situation is caused by the consumption of H⁺ ions in the solvent medium in accordance with the hydration reaction. With the progress of the dissolution, the ratio of H⁺ ion consumed decreased, and as a result of this, the increase in the pH value of the 2% citric acid solution slowed down. During the dissolution of the glass samples in distilled water, it was observed that the pH value stabilized after a while. This situation is caused by the fact that the ions passing from the glass structure to the solvent medium reach a level to form a buffer solution after a while.

As a result of the pH monitoring, it was determined that 2% citric acid solution did not cause a significant change in the pH value during the dissolution of the samples, and the pH value of the distilled water remained within the range of pH value required for the development of the tomato plant.

In the P₂O₅—CaO—SiO₂—Al₂O₃—Na₂O—K₂O system, in order to examine the change in the physical properties of glass samples with the SiO₂ component (SiO₂/Na₂O+K₂O) added to the structure in response to the decreasing ratio of alkali oxide in equal amounts, the values of density, theoretical density, molar volume, oxygen molar volume and oxygen packing density were determined and given in Table 19. However, the changes in density, molar volume, oxygen molar volume and oxygen packing density depending on the SiO₂ added to the composition are shown in FIGS. 1A-1C.

TABLE 19
The values of density (ρ), molar volume (V_{M}), oxygen molar volume (V_{O})
and oxygen packing density (OPD) of the samples of glass
obtained in P₂O₅—CaO—SiO₂—Al₂O₃—Na₂O—K₂O system

| | | | V_{M} | V_{O} | |
|---|---|---|---|---|---|
| | ρ | ρ_{Theoretical} | (cm³/ | (cm³/ | OPD |
| Sample | (g/cm³) | (g/cm³) | mol) | mol) | (mol/L) |
| P45C20A5N15K15 | 2.63 | 2.60 | 39.41 | 13.59 | 73.58 |
| P45C20S5A5N12.5K12.5 | 2.60 | 2.61 | 39.58 | 13.42 | 74.53 |

According to the calculated values of the theoretical density, the densities of the samples are expected to increase with an increasing ratio of SiO₂/Na₂O+K₂O. However, when the experimental results were examined, it was observed that there was a decrease in the density with the increase of the ratio of SiO₂ in the structure. With an increasing ratio of SiO₂/Na₂O+K₂O in the composition, a decrease in the mass occurred. It is thought that the decrease in the density due to the introduction of SiO₂ into the structure is caused by this situation. The molar volume value, on the other hand, showed a slight increase with the addition of SiO₂ to the structure. This situation is caused by the decrease in the density.

When the calculated values of oxygen molar volume were examined, a decrease was observed in the oxygen molar volume with an increasing ratio of SiO₂/Na₂O+K₂O. This situation is a result of the structure becoming more tightly packed as Si⁺⁴ (1.57) ion with high field strength replaces K⁺ (013) and Na⁺ (0.19) ions. The oxygen packing densities increased, as SiO₂ replaced K₂O and Na₂O with ½ of the lower oxygen atoms.

The thermograms obtained as a result of the thermal analysis of the glass samples synthesized in the P₂O₅—CaO—SiO₂—Al₂O₃—Na₂O—K₂O system are given in FIG. 2, and in the range of 25-500° C. where DTA analysis was performed, only the glass transition reactions were seen, and no crystallization peak was observed. Therefore, the thermal stability values of the obtained samples could not be determined.

When the obtained results were examined, it was determined that the glass transition temperature increased from 376° C. to 400° C. with the increase in the ratio of SiO₂/Na₂O+K₂O. This increase observed in the glass transition temperature is a result of the formation of stronger bonds in the network structure as a result of the participation of SiO₂ in the network structure formation in the form of [SiO₄] tetrahedron.

The FTIR spectra of the glass samples synthesized in P₂O₅—CaO—SiO₂—Al₂O₃—Na₂O—K₂O system are given in FIG. 3. However, the O/P values of the samples were calculated, and it was determined that this value increased from 3.2 to 3.3 with an increasing ratio of SiO₂/Na₂O+K₂O.

When the spectrum obtained as a result of the structural analysis was examined, it was determined that the peak around 534 cm⁻¹ represented the O═P—O or P—O—P bonds. With the addition of SiO₂ to the structure, formation of a shoulder at the wave number of ˜499 cm⁻¹ was observed, and it was determined that this was due to the bending vibrations of Si—O—Si and Si—O—P bonds. However, it was determined that the peaks, which were caused by the symmetrical vibrations of the P—O—P bonds and observed at the wave numbers of 710 cm⁻¹, 757 cm⁻¹ and 883 cm⁻¹, were shifted to higher wave numbers with an increasing ratio of SiO₂/Na₂O+K₂O. Wu et al. stated in their study that this is an indication of the formation of stronger bonds in the structure. However, it was determined that the peak at the wave number of ˜1103 cm⁻¹ was shifted to a lower wave number with the addition of SiO₂ to the composition, and it is thought that the reason for this situation may be the formation of the Si—O—P bonds in the structure. In addition, it was determined that the peaks observed around ˜980 cm⁻¹, ˜1184 cm⁻¹ were caused by the asymmetric vibration of the P—O—P bonds of the Q² unit and the symmetrical vibration of the PO₂⁻ group of the Q² unit, respectively and their intensity decreased with SiO₂ added to the composition, and it was observed that the intensity of the peak at 1263 cm⁻¹, which represents the asymmetric vibration of the PO₂⁻ group of the Q² unit, increased.

The data obtained from the weight loss examinations of the glass samples synthesized in the P₂O₅—CaO—SiO₂—Al₂O₃—Na₂O—K₂O system in 2% citric acid solution and distilled water medium, are given in FIGS. 4A-4B along with the calculated average ratio of the dissolution.

When the results obtained were examined, it was determined that the dissolution in distilled water medium proceeded faster with the addition of SiO₂ to the composition, and it was determined that this was caused by the fact that the Si—O—P bonds in the structure were sensitive to the hydrolysis. On the other hand, when the dissolution behavior of the samples in 2% citric acid solution was examined, it was observed that the dissolution slowed down with the addition of SiO₂ to the composition. Menaa et al. doped the silicophosphate glass with organic acids in their study and suggested that the organic-inorganic hybrid structure formed as a result of the presence of the carboxylic groups in the structure increases the chemical resistance by strengthening the Si—O—P bonds. This explains the slowing down the dissolution behavior in acidic medium with SiO₂ added to the composition.

The changes in the pH value of the solvent during the dissolution of the glass samples obtained in the P₂O₅—CaO—SiO₂—Al₂O₃—Na₂O—K₂O system in 2% citric acid solution and distilled water medium are given in FIGS. 5A-5B.

When the results obtained were examined, it was determined that the pH value of both solvent media increased as a result of the consumption of the H⁺ ion in the solvent in accordance with the hydration reaction in the first stages of the dissolution. It was observed that the increase in the pH value slowed down with the decrease of H+ ion consumed in the following stages of the dissolution in the solution of 2% citric acid. During the dissolution in distilled water, it was determined that the pH value of the solvent of the sample containing SiO₂ began to decrease after 168 hours, and it was thought that this might caused by the deprotonation of the P—OH group formed as a result of the hydrolysis reaction, depending on the pH of the solution.

As a result of the pH monitoring carried out during the dissolution of the samples, it was determined that both samples did not cause a critical pH change for the development of the tomato plant in the solution of 2% citric acid and the pH value of the distilled water remained in a suitable range for the development of the tomato plant throughout the dissolution process. By evaluating the physical, thermal, structural analysis results and dissolution behavior of all synthesized samples, it was determined that the sample of P45C20S5A5N12.5K12.5 is the most suitable glass for the development of tomato plants. The selected sample of P45C20S5A5N12.5K12.5 was used as a glass fertilizer in the pot experiments with the tomato plants with and without additives (MnO2, Fe2O3, ZnO, B2O3, CuO, MoO3). The tomato plants were grown in 4 different soils containing no fertilizer, a glass a fertilizer, a glass fertilizer with a microelement additive and a chemical fertilizer (NPK) and as a result of the pot experiments, a glass fertilizer without a microelement additive showed the greatest improvement with a height increase of 12.3 cm and average leaf size of 3.01 cm. However, when the fruits obtained as a result of the pot experiments were examined, the weight and diameter values of the fruits obtained from the tomato plant grown in the pots without a fertilizer were determined to be 5.67 g and 22.09 cm, respectively, and it was determined that they had the highest grade when compared to the fruits of the other plants. As a result of the pot experiments carried out for over 60 days, it was observed that the glass fertilizer without a microelement additive had a promising effect on the development of the tomato plants.

What is claimed is:

1. A controlled release glass fertilizer composition, comprising at least one macro element selected from the group consisting of 28-50 P₂O₅, 36>CaO, 25>SiO₂, 0.1-10 Al₂O₃, 20>Na₂O, and 20>K₂O as a mole percent, an oxide selected from the group consisting of SO₃ and MgO, and a microelement selected from the group consisting of Mn, Cu, B, Mo, Zn, and Fe, wherein a glass transition temperature of the controlled release glass fertilizer composition is adjusted above 230° C.

2. The controlled release glass fertilizer composition according to claim 1, wherein Na₂O ve K₂O are selected together as the at least one macro element.

3. The controlled release glass fertilizer composition according to claim 1, wherein the at least one macro element is composed of P₂O₅, CaO, Na₂O, K₂O and the oxide comprises SO₃, MgO, SiO₂, and Al₂O₃.

4. The controlled release glass fertilizer composition according to claim 3, wherein a density is adjusted to 2.54 g/cm³ for a mole percent ratio of 50P₂O₅20CaO15K₂O15Na₂O according to a ratio of Na₂O/Na₂O+K₂O in the controlled release glass fertilizer composition.

5. The controlled release glass fertilizer composition according to claim 3, wherein a wave number of an FTIR spectrum comprises a reflectance peak between 520-540, 865-880, 1080-1090, and 1260-1340 cm⁻¹.

6. The controlled release glass fertilizer composition according to claim 3, wherein a pH change in a citric acid solution of 2% is adjusted less than 0.75 for over 600 hours.

7. The controlled release glass fertilizer composition in according to claim 1, wherein the at least one macro element is composed of P₂O₅, CaO, Al₂O₃, Na₂O, and K₂O and the oxide comprises SO₃, MgO ve SiO₂.

8. The controlled release glass fertilizer composition according to claim 7, wherein according to a ratio of Al₂O₃/P₂O₅ in the controlled release glass fertilizer composition, a density is adjusted to 2.63 g/cm³ for a mole percent ratio of 45P₂O₅20CaO5Al₂O₃15Na₂O15K₂O.

9. The controlled release glass fertilizer composition according to claim 7, wherein a wave number of an FTIR spectrum comprises a reflectance peak between 530-550, 880-905, 1100-1120, and 1180-1270 cm⁻¹.

10. The controlled release glass fertilizer composition according to claim 7, wherein a pH change in a citric acid solution of 2% is adjusted less than 0.75 for over 600 hours.

11. The controlled release glass fertilizer composition according to claim 1, wherein the at least one macro element is composed of P₂O₅, CaO, SiO₂, Al₂O₃, Na₂O ve K₂O and the oxide comprises SO₃ ve MgO.

12. The controlled release glass fertilizer composition according to claim 11, wherein a density is adjusted to 2.60 g/cm₃ for a mole percent ratio of 45P₂O₅20CaO5SiO₂5Al₂O₃12.5Na₂O12.5K₂O according to a ratio of SiO₂/Na₂O+K₂O in the controlled release glass fertilizer composition.

13. The controlled release glass fertilizer composition according to claim 11, wherein a wave number of an FTIR spectrum comprises a reflectance peak between 490-535, 880-895, 1090-1100, and 1260-1265 cm⁻¹.

14. The controlled release glass fertilizer composition according to claim 11, wherein a pH change in a citric acid solution of 2% is adjusted less than 0.75 for over 600 hours.

15. A method of producing tomatoes (Lycopersicon Esculentum), comprising using the controlled release glass fertilizer composition except for a sample of 50P₂O₅20CaO30K₂O according to claim 1.

16. The controlled release glass fertilizer composition according to claim 2, wherein the at least one macro element is composed of P₂O₅, CaO, Na₂O, K₂O and the oxide comprises SO₃, MgO, SiO₂, and Al₂O₃.

17. The controlled release glass fertilizer composition according to claim 4, wherein a wave number of an FTIR spectrum comprises a reflectance peak between 520-540, 865-880, 1080-1090, and 1260-1340 cm⁻¹.

18. The controlled release glass fertilizer composition according to claim 4, wherein a pH change in a citric acid solution of 2% is adjusted less than 0.75 for over 600 hours.

19. The controlled release glass fertilizer composition according to claim 5, wherein a pH change in a citric acid solution of 2% is adjusted less than 0.75 for over 600 hours.

20. The controlled release glass fertilizer composition according to claim 2, wherein the at least one macro element is composed of P₂O₅, CaO, Al₂O₃, Na₂O, and K₂O and the oxide comprises SO₃, MgO ve SiO₂.
